(19) United States
(12) Patent Application Publication
(10) Pub. No.: US 2015/0134515 A1
(43) Pub. Date: May 14, 2015

(54) METHODS AND SYSTEMS FOR ELECTRONIC PAYMENT OF A CONSUMER'S BILLS

(71) Applicant: Brian Cosgray, Atlanta, GA (US)

(72) Inventor: Brian Cosgray, Atlanta, GA (US)

(21) Appl. No.: 14/074,952

(22) Filed: Nov. 8, 2013

(51) Int. Cl. G06Q 20/10

(52) U.S. Cl. CPC G06Q 20/102
USPC 705/40

(57) ABSTRACT

An example method for electronic payment of consumer bills can include receiving enrollment information from a consumer, and using the enrollment information, obtaining information related to a consumer bill. The information can include an amount due for the consumer bill. The method can also include transmitting a payment reminder for the consumer bill to the consumer, and receiving a payment authorization for the consumer bill from the consumer. Further, the method can include transmitting a request to an employer or payroll processor for the consumer to withhold the amount due from the consumer's paycheck, and then, paying the amount due on behalf of the consumer.

### BACKGROUND

Traditionally, a consumer's bills have been paid at the consumer level, for example, from pay deposited in the consumer's bank account or cash from a cashed paycheck. In other words, the consumer's bills have traditionally been paid from the consumer's net pay. Bills directly withheld from the consumer's paycheck at the employer level (i.e., withheld from the consumer's gross pay) have traditionally been benefits enjoyed by multiple employees such as parking, healthcare, or childcare.

The traditional post-pay (or net pay) bill payment process is time consuming for consumers. In particular, collecting the bills, scheduling their payments, and balancing household cash flow needs between unexpected or forgotten bills and discretionary spending can make life stressful, especially for consumers with low financial literacy.

It is therefore desirable to provide improved methods and systems for helping consumers manage their bills.

### SUMMARY

Described herein are methods and systems for electronic bill payment. More particularly, described herein are methods and systems for facilitating payment of one or more of a consumer's bills through a withholding from the consumer's paycheck (or gross pay). Instead of the consumer paying consumer bills from “take-home pay” or net pay (e.g., the portion of the consumer's paycheck after taxes and/or contributions to insurance, 401k, etc. are deducted), the consumer's bills are withheld from his paycheck and paid on the consumer's behalf. For example, described herein are methods and systems for electronically obtaining information related to a consumer's bill, submitting the amount due for of the consumer's bill to the consumer's employer or payroll processor for withholding from the consumer's paycheck, and paying the consumer's bill on behalf of the consumer in a timely manner. Also described herein are methods and systems for electronically consolidating a plurality of the consumer's bills, submitting the total amount due for the consumer's bills to the consumer's employer or payroll processor for withholding from the consumer's paycheck, and paying the consumer's bills on behalf of the consumer in a timely manner.

An example method for electronic payment of consumer bills can include receiving enrollment information from a consumer, and using the enrollment information, obtaining information related to a consumer bill. The information can include an amount due for the consumer bill. The method can also include transmitting a payment reminder for the consumer bill to the consumer, and receiving a payment authorization for the consumer bill from the consumer. Further, the method can include transmitting a request to an employer or payroll processor for the consumer to withhold the amount due from the consumer's paycheck, and then, paying the amount due on behalf of the consumer.

Optionally, the method can include obtaining information related to each of a plurality of consumer bills. The information related to each of the consumer bills can include a respective amount due. The method can also include consolidating (or adding, summing, etc.) the respective amount due for each of the consumer bills to obtain a total amount due, and transmitting a request to an employer or payroll processor for the consumer to withhold the total amount due from the consumer's paycheck. In this way, the method may be virtually transparent to the employer, as the method of collecting billing information, requesting a consolidated payment from the employer, and paying disparate billers may all be handled by the bill payment provider. In one example implementation, this also allows for the off-loading of time-consuming administrative tasks on the part of the employer (e.g., portal maintenance, billing information collection) in favor of a third-party bill pay provider that is geographically remote from the employer and/or not part of the employer's primary business activities.

Optionally, the enrollment information can include the consumer's demographic information or account information for the consumer bill. It should be understood that enrollment information can be collected/obtained for each of a plurality of consumer bills. The consumer's demographic information can optionally include, but is not limited to, the consumer's name, address, date of birth, etc. The account information can optionally include, but is not limited to, an account number, account username, account password, account personal identification number, etc. The enrollment information can be used to obtain the information related to the consumer bill. Optionally, the information related to the consumer bill can include an amount due and a due date for the consumer bill. When there are a plurality of consumer bills, the information (e.g., amount due and/or due date) can be respectively related to each of the consumer bills.

Optionally, the method can include obtaining information related to the consumer bill during a pay period for the consumer, transmitting a request to withhold the amount due from the consumer's paycheck to the employer or payroll processor for the consumer during the pay period, and paying the amount due on behalf of the consumer before the due date for the consumer bill.

Alternatively or additionally, the payment reminder for the consumer bill can optionally be an e-mail or a push notification.

Alternatively or additionally, paying the amount due on behalf of the consumer can include authorizing a credit transfer from a designated account. For example, the credit transfer can optionally be an automated clearing house (ACH) credit transfer.

Optionally, the method can further include transmitting a confirmation of payment of the consumer bill to the consumer. Alternatively or additionally, the method can optionally further include transmitting a payment report for the consumer bill to a credit reporting agency.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a block diagram of an example environment for implementing electronic bill payment as described herein;

FIG. 2 is a flow diagram illustrating example operations for electronic bill payment as described herein; and

FIG. 3 is a block diagram of an example computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. While implementations will be described for electronic consumer bill payment, it will become evident to those skilled in the art that the implementations are not limited thereto.

According to the methods and systems described herein, an employer or third-party can offer an electronic consumer bill pay service (e.g., a bill pay service). Additionally, an employee (also referred to herein as “a consumer”) can enroll in the bill pay service offered by the employer or third-party. For example, the employee can enter information related to one or more of the employee's consumer bills such as the consumer's demographic information and/or account information in to a web-based, application or mobile application portal. As used herein, the employee's consumer bills can include, but are not limited to, utility bills (e.g., gas, electric, water, sewage, etc.), consumer credit card bills, consumer loan bills (e.g., mortgage, student loans, auto loans, etc.) or any other service bills (e.g., cable, Internet, mobile phone, childcare, home maintenance, home owner's association, etc.). The bill pay service can pull (or obtain) the amount due for each of the employee's consumer bills during the upcoming pay cycle and can transmit the total amount due to the employer. The employer can withhold the total amount due from the employee's paycheck. The bill pay service can debit a designated payroll account for the total amount of the withheld funds and can pay the consumer bills on the employee's behalf. By automatically withholding the total amount due for the employee's consumer bills from the employee's paycheck, it is possible to facilitate tracking and timely payment of the employee's consumer bills. Timely payment of consumer bills can result in improved credit scores and also reduce the employee's stress levels caused by financial management. As noted, this disclosure contemplates that in at least one implementation the bill data (e.g., the amount due and/or due date for each of the employee's consumer bills) can be collected and submitted to the bill pay provider by a third party. Additionally, this disclosure contemplates that at least in one implementation the payment processing (e.g., paying the employee's consumer bills) can also be performed by a third party.

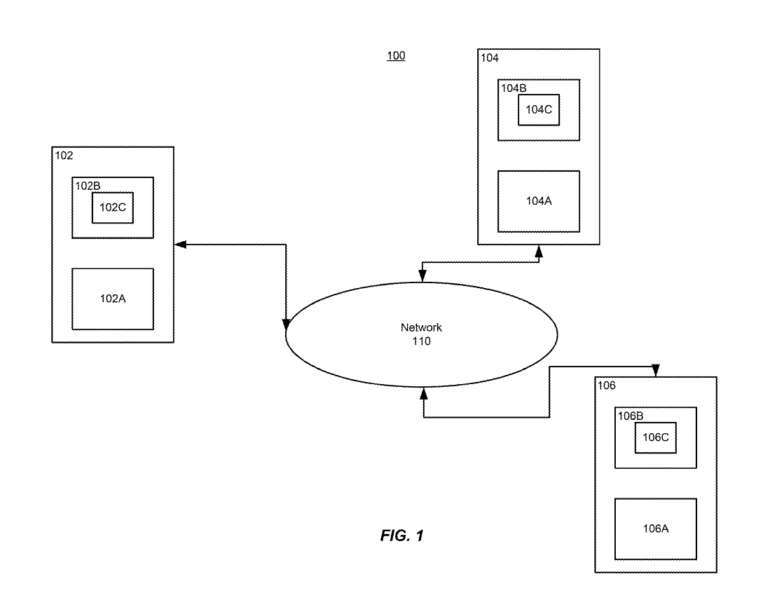

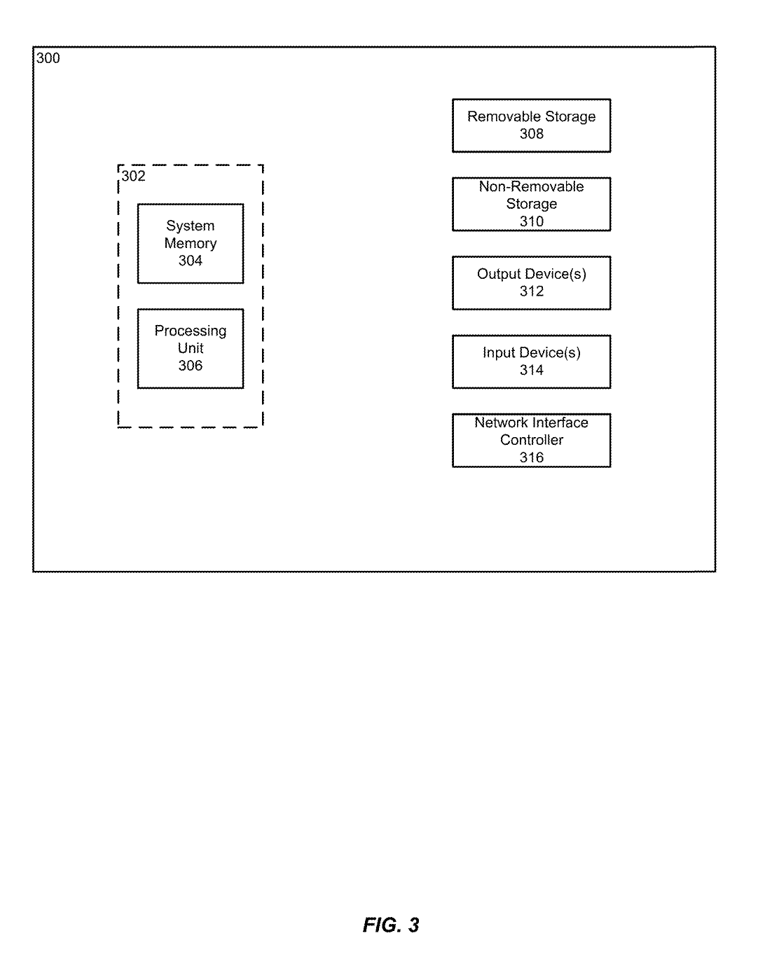

Referring to FIG. 1, a block diagram of an example environment 100 for implementing electronic bill payment is shown. The example environment 100 can include a consumer computing system 102, an employer computing system 104 and a bill pay provider computing system 106. This disclosure contemplates that the consumer computing system 102, the employer computing system 104 and the bill pay provider computing system 106 can be one or more computing devices such as the example computing device described with regard to FIG. 3 below. In at least one example implementation, the bill provider computer system 106 is geographically remote from the employer and/or not part of the employer's primary business activities. This allows for consolidation of bills by the bill provider computer system 106 to be virtually transparent to the operations of the employer computing system 104 (i.e., transparent apart from a request for a single debit equaling an amount equal to the amount of the consolidated bills submitted by the bill provider computer system 106 to the employer computing system 104).

As shown in FIG. 1, the consumer computing system 102, the employer computing system 104 and the bill pay provider computing system 106 can be communicatively connected through a network 110. It should be understood that the network 110 can include one or more suitable networks. The networks can be similar to each other in one or more respects. Alternatively or additionally, the networks can be different from each other in one or more respects. The networks can include a local area network (LAN), a wireless local area network (WLAN), a wide area network (WAN), a metropolitan area network (MAN), a virtual private network (VPN), etc., including portions or combinations of any of the above networks. In addition, the consumer computing system 102, the employer computing system 104 and the bill pay provider computing system 106 can be coupled to the networks through one or more communication links. This disclosure contemplates the communication links are any suitable communication link. For example, a communication link may be implemented by any medium that facilitates data exchange between the network elements including, but not limited to, wired, wireless and optical links. Example communication links include, but are not limited to, a LAN, a WAN, a MAN, Ethernet, the Internet, or any other wired or wireless link such as WiFi, WiMax, 3G or 4G.

Additionally, the consumer computing system 102 can optionally be a desktop or laptop computer, a handheld mobile device, a tablet, etc. The consumer computing system 102 can be provided with one or more client applications for providing user interaction with the consumer computing system 102 and/or other devices connected to the network 110 (e.g., the employer computing system 104 and/or the bill pay provider computing system 106). For example, client applications 102C can include a web browser and/or a bill pay application (e.g., an application and/or mobile application portal) that allows a consumer (also referred to herein as “an employee”) to arrange for electronic payment of the consumer's bills through payroll withholding as described in detail below. Client applications 102C can optionally be computer-executable instructions (e.g., software) stored in a system memory 102B executed by a processing unit 102A. Alternatively or additionally, the employer computing system 104 and/or the bill pay provider computing system 106 can optionally be one or more server computers. Similar to above, the employer computing system 104 and/or the bill pay provider computing system 106 can be provided with one or more bill pay applications for providing user interaction with the consumer computing system 102 and/or other devices connected to the network 110. For example, bill pay applications 104C/106C can include a web-based portal and/or a bill pay application that allows the consumer to arrange for electronic payment of the consumer's bills through payroll withholding as described in detail below. Client applications 104C/106C can optionally be computer-executable instructions (e.g., software) stored in a system memory 104B/106B executed by a processing unit 104A/106A. In one example embodiment, the consumer may set certain attributes for the payment through the bill pay applications 104C/106C. For example, the consumer may specify the date for payment of bill; instructions for partial payment of a bill; or instructions for deducting a fixed (e.g., minimum or maximum) amount of funds to be withdrawn from the net pay of the employer, to then be spread equally or on a percentage basis toward the payment of multiple bills.

The example environment 100 shown in FIG. 1 is provided only as an example. Accordingly, it should be understood that the example environment 100 can include more or fewer elements and/or be configured differently than as shown in FIG. 1.

It should be appreciated that the logical operations described herein with respect to the various figures may be implemented (1) as a sequence of computer implemented acts or program modules (i.e., software) running on a computing device, (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

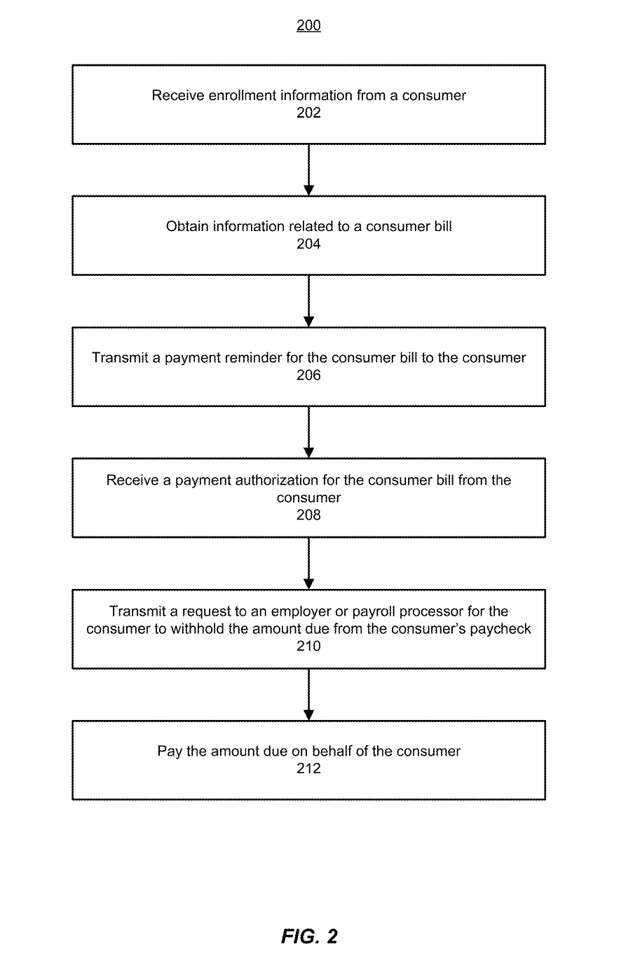

Referring now to FIG. 2, a flow diagram illustrating example operations 200 for electronic bill payment is shown. As described above, an employer or third-party can offer an electronic consumer bill pay service. Additionally, an employee (e.g., a consumer) can enroll in the bill pay service offered by the employer or third-party. The bill pay service can be provided by a bill service provider, for example. This disclosure contemplates that the bill service provider can charge at least one of the employer or the consumer a fee for providing such a service.

The consumer can enroll in the bill pay service, for example, using the consumer computing system 102 of FIG. 1. For example, the consumer can enter enrollment information using a web-based or application portal (e.g., client application 102C of FIG. 1). The enrollment information can include any information needed to obtain information related to the consumer's bill. As described above, the consumer's bill can be a consumer bill, e.g., a utility bill (e.g., gas, electric, water, sewage, etc.), consumer credit card bill, consumer loan bill (e.g., mortgage, student loans, auto loans, etc.) or any other service bill (e.g., cable, Internet, mobile phone, etc.). Optionally, the enrollment information can include the consumer's demographic information or account information for the consumer bill. For example, the consumer's demographic information can optionally include, but is not limited to, the consumer's name, address, date of birth, etc. The account information can optionally include, but is not limited to, an account number, account username, account password, account personal identification number, etc. This disclosure contemplates that the enrollment information can include data other than the consumer's demographic information and/or the account information. In some implementations, the enrollment information can include any information needed to obtain information related to a plurality of the consumer's bills. Accordingly, the enrollment information can be entered for each of the consumer's bills, including but not limited to, attributes for timing and amount for each bill payment. At 202, the enrollment information can be received from the consumer, for example, using the bill pay provider computing system 106 of FIG. 1. For example, the enrollment information can be communicated from the consumer computing system 102 to the bill pay provider computing system 106 over the network 110.

At 204, information related to the consumer's bill can be obtained using the enrollment information. The information related to the consumer's bill can be obtained electronically using the bill pay provider computing system 106 of FIG. 1, for example, from the consumer's creditor. Alternatively, in some implementations, the information related to the consumer's bill can be obtained electronically by a third party (e.g., an entity other than the bill pay provider) from the consumer's creditor and then provided to the bill pay provider by the third party. Optionally, the information related to the consumer's bill can include an amount due for the consumer's bill. Alternatively or additionally, the information related to the consumer's bill can optionally include an amount due and a due date for the consumer's bill. This disclosure contemplates that the information can include data other than the amount due and/or the due date, including but not limited to, usage fees (e.g., fees per therms, gallons, minutes, etc.) or transaction history. Similar to the above, in some implementations, information related to each of the plurality of the consumer's bills can be obtained from each of the consumer's creditors, respectively. In addition, in some implementations, the information related to the consumer's bill can be obtained during a pay period for the consumer. The pay period can optionally be a current pay period for the consumer. Alternatively or additionally, the information related to the consumer's bill can be automatically obtained during each new pay period for the consumer.

At 206, a payment reminder for the consumer's bill can be transmitted to the consumer, for example, using the bill pay provider computing system 106 of FIG. 1. Optionally, the payment reminder for the consumer's bill can be an e-mail or a push notification. In response to the payment reminder, a payment authorization for the consumer's bill can be transmitted to the bill pay provider, for example, using the consumer computing system 102 of FIG. 1. Optionally, the payment authorization for the consumer's bill can be an acknowledgement to the e-mail or push notification reminder. At 208, the payment authorization for the consumer's bill can be received from the consumer, for example, using the bill pay provider computing system 106 of FIG. 1. In some implementations, a payment reminder for each of the plurality of the consumer's bills can be transmitted and respectively authorized (or not authorized) for payment by the consumer. In another implementation, the consumer may chose to modify one or more attributes of the enrollment information related to one or more consumer bills in response to the notification. This disclosure contemplates that the payment reminders and/or the payment authorizations can be transmitted between the consumer computing system 102 and the bill pay provider computing system 106 over the network 110, for example. Alternatively or additionally, the reminder(s) and/or authorization(s) can be communicated during the pay period (e.g., the current pay period) and/or before the due date for the consumer's bill.

At 210, a request can be transmitted to an employer or payroll processor for the consumer to withhold the amount due for the consumer's bill from the consumer's paycheck, for example, using the bill pay provider computing system 106 of FIG. 1. The request can be received by the employer or payroll processor for the consumer using the employer computing system 104 of FIG. 1, for example. This disclosure contemplates that the request can be communicated from the bill pay provider computing system 106 to the employer computing system 104 over the network 110, for example. As described above, in some implementations, the consumer has a plurality of consumer bills. In these cases, the information related to each of the consumer's bills, including a respective amount due for each of the consumer's bills, can be obtained. The respective amount due for each of the consumer's bills can be consolidated (e.g., added, summed, etc.) to obtain a total amount due, for example, using the bill pay provider computing system 106 of FIG. 1. Accordingly, the withholding request transmitted to the employer or payroll processor for the consumer can include the total amount due for the consumer's bills. Thus, in at least one implementation, the employer may initiate a deposit of the funds necessary to cover the debit in an account associated with the bill pay provider in response to the withholding requested sent by the bill pay provider computing system 106 of FIG. 1 to the employer computer system 104 of FIG. 1. Alternatively, before or after the withholding request, the bill pay service provider can debit a designated payroll account for the amount due (or the total amount due), i.e., the withheld funds.

At 212, the amount due (or the total amount due) can be paid on behalf of the consumer. For example, a credit transfer from a designated account at the bill pay provider can be authorized, for example, using the bill pay provider computing system 106 of FIG. 1. Optionally, the credit transfer can be an ACH credit transfer. Alternatively, in some implementations, the credit transfer from a designated account can be authorized by a third party (e.g., an entity other than the bill pay provider). Optionally, the credit transfer from the designated account can optionally be authorized before the due date for the consumer's bill. Alternatively or additionally, the credit transfer from the designated account can be authorized within a predetermined period of time such as three days, for example. It should be understood that the predetermined period of time can be more or less than three days, which is provided only as an example. The predetermined period of time can optionally be selected to ensure that the consumer's bills are timely paid before the due date.

Optionally, a confirmation of payment of the consumer's bills can be transmitted to the consumer, for example, using the bill pay provider computing system 106 of FIG. 1. The confirmation of payment of the consumer's bills can be received by the consumer using the consumer computing system 102 of FIG. 1, for example. This disclosure contemplates that the confirmation of payment of the consumer's bills can be communicated from the bill pay provider computing system 106 to the consumer computing system 102 over the network 110, for example.

Alternatively or additionally, a payment report for the consumer's bills can be transmitted to a credit reporting agency, for example, using the bill pay provider computing system 106 of FIG. 1. The credit reporting agency can include, but is not limited to, EQUIFAX of ATLANTA, GA; EXPERIAN of COSTA MESA, CA; or TRANS UNION of CHESTER, PA. The payment report can optionally indicate timely or late payment of the consumer's bills. This disclosure contemplates that the payment report for the consumer's bills can be communicated from the bill pay provider computing system 106 to the credit reporting agency over the network 110, for example.

As noted, the above process is exemplary, and additional steps may be implemented consistent with this disclosure. For example, in another implementation, withholding of a customer's payroll funds may be accomplished through the use of a payroll card so as to avoid a direct deduction from payroll. In this way, funds sufficient to cover bill payments may be deducted from an account associated with the payroll card (e.g., the bill pay provider may be allowed to withdraw funds from an account associated with the payroll card). Alternatively, a deduction of funds to cover consolidated or individual bill payments may be performed by a bill pay provider by pinging an employee's (or third-party's) bank account as soon as the account is credited with the net pay from the employee's employer. To do so, the employee may provide specific instructions to the bill pay provider and his or her bank to allow for the deduction of funds sufficient to cover bills being paid by the bill pay provider at or near the time the funds from an employer are electronically other otherwise received in the employee's bank account.

Optionally, in another example implementation, a non-card stored value account (i.e., virtual account) or card linked stored value account may be used to facilitate the withholding of a customer's payroll funds. In this implementation, the bill pay provider or a third party may create a non-card stored value account through the use of an API (SOAP and/or REST). Subsequently (beneficially at the time the employee signs up for the service), the bill pay provider can then send instructions to the employer to change the direct deposit for the employee to the virtual account (or card linked stored value account). If performed this way, the employer net pay funds will then be deposited on payday to the virtual account maintained by the bill pay provider or a third-party (or, alternatively, deposited to a card linked stored value account), from which the remainder of funds not necessary to pay bills through the bill pay provider will be deposited to the employee's permanent direct deposit account or payroll card. In at least one implementation, the bill pay provider is provided authorization by the employee to creates and maintain the virtual account or process funds through the card linked stored value account. Accordingly, the bill pay provider directs the distribution of funds from the virtual account or card linked stored value account once payroll funds are distributed to it (e.g., funds are distributed by the bill pay provider to the employee's bank account and/or payroll card and the bill pay provider processes payment of one or more bills on the employees behalf as further described herein).

When the logical operations described herein are implemented in software, the process may execute on any type of computing architecture or platform. For example, referring to FIG. 3, an example computing device upon which embodiments of the invention may be implemented is illustrated. In particular, the consumer computing system 102, the employer computing system 104 and the bill pay provider computing system 106 can be one or more computing devices, such as computing device 300 shown in FIG. 3. The computing device 300 may include a bus or other communication mechanism for communicating information among various components of the computing device 300. In its most basic configuration, computing device 300 typically includes at least one processing unit 306 and system memory 304. Depending on the exact configuration and type of computing device, system memory 304 may be volatile (such as random access memory (RAM)), non-volatile (such as read-only memory (ROM), flash memory, etc.), or some combination of the two. This most basic configuration is illustrated in FIG. 3 by dashed line 302. The processing unit 306 may be a standard programmable processor that performs arithmetic and logic operations necessary for operation of the computing device 300.

Computing device 300 may have additional features/functionality. For example, computing device 300 may include additional storage such as removable storage 308 and non-removable storage 310 including, but not limited to, magnetic or optical disks or tapes. Computing device 300 may also contain network connection(s) 316 that allow the device to communicate with other devices. Computing device 300 may also have input device(s) 314 such as a keyboard, mouse, touch screen, etc. Output device(s) 312 such as a display, speakers, printer, etc. may also be included. The additional devices may be connected to the bus in order to facilitate communication of data among the components of the computing device 300. All these devices are well known in the art and need not be discussed at length here.

The processing unit 306 may be configured to execute program code encoded in tangible, computer-readable media. Computer-readable media refers to any media that is capable of providing data that causes the computing device 300 (i.e., a machine) to operate in a particular fashion. Various computer-readable media may be utilized to provide instructions to the processing unit 306 for execution. Common forms of computer-readable media include, for example, magnetic media, optical media, physical media, memory chips or cartridges, a carrier wave, or any other medium from which a computer can read. Example computer-readable media may include, but is not limited to, volatile media, non-volatile media and transmission media. Volatile and non-volatile media may be implemented in any method or technology for storage of information such as computer readable instructions, data structures, program modules or other data and common forms are discussed in detail below. Transmission media may include coaxial cables, copper wires and/or fiber optic cables, as well as acoustic or light waves, such as those generated during radio-wave and infra-red data communication. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 306 may execute program code stored in the system memory 304. For example, the bus may carry data to the system memory 304, from which the processing unit 306 receives and executes instructions. The data received by the system memory 304 may optionally be stored on the removable storage 308 or the non-removable storage 310 before or after execution by the processing unit 306.

Computing device 300 typically includes a variety of computer-readable media. Computer-readable media can be any available media that can be accessed by device 300 and includes both volatile and non-volatile media, removable and non-removable media. Computer storage media include volatile and non-volatile, and removable and non-removable media implemented in any method or technology for storage of information such as computer readable instructions, data structures, program modules or other data. System memory 304, removable storage 308, and non-removable storage 310 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 300. Any such computer storage media may be part of computing device 300.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for electronic payment of consumer bills, comprising:
receiving enrollment information from a consumer at a bill pay provider;
using the enrollment information, obtaining information related to a consumer bill at the bill pay provider, the information including an amount due;
transmitting from the bill pay provider a payment reminder for the consumer bill to the consumer;
receiving at the bill pay provider a payment authorization for the consumer bill from the consumer;
transmitting from the bill pay provider a request to an employer or payroll processor for the consumer to withhold the amount due from the consumer's paycheck; and
paying the amount due on behalf of the consumer from an account associated with the bill pay provider.

2. The method of claim 1, wherein obtaining information related to a consumer bill further comprises obtaining information related to each of a plurality of consumer bills, the information related to each of the consumer bills including a respective amount due, the method further comprising consolidating the respective amount due for each of the consumer bills to obtain a total amount due, and wherein transmitting a request to an employer or payroll processor for the consumer to withhold the amount due from the consumer's paycheck further comprises transmitting a request to withhold the total amount due from the consumer's paycheck.

3. The method of claim 1, wherein the enrollment information comprises the consumer's demographic information or account information for the consumer bill.

4. The method of claim 1, wherein the information related to the consumer bill further includes a due date for the consumer bill.

5. The method of claim 4, wherein:
the information related to the consumer bill is obtained during a pay period for the consumer,
the request to withhold the amount due from the consumer's paycheck is transmitted to the employer or payroll processor for the consumer during the pay period, and
the amount due is paid on behalf of the consumer before the due date.

6. The method of claim 1, wherein the payment reminder for the consumer bill is an e-mail or a push notification.

7. The method of claim 1, wherein paying the amount due on behalf of the consumer further comprises authorizing an electronic credit transfer from a designated account held by the bill pay provider.

8. The method of claim 7, wherein the credit transfer is an automated clearing house (ACH) credit transfer.

9. The method of claim 1, further comprising transmitting a confirmation of payment of the consumer bill to the consumer.

10. The method of claim 1, further comprising transmitting a payment report for the consumer bill to a credit reporting agency.

11. A system for electronic payment of consumer bills, comprising:
at least one processor; and
a memory in communication with the processor, the memory having computer-executable instructions stored thereon that, when executed by the processor, cause the system to:
receive enrollment information from a consumer;
using the enrollment information, obtain information related to a consumer bill, the information including an amount due;
transmit a payment reminder for the consumer bill to the consumer;
receive a payment authorization for the consumer bill from the consumer;
transmit a request to an employer or payroll processor for the consumer to withhold the amount due from the consumer's paycheck; and
pay the amount due on behalf of the consumer.

12. The system of claim 11, wherein obtaining information related to a consumer bill further comprises obtaining information related to each of a plurality of consumer bills, the information related to each of the consumer bills including a respective amount due, the memory having further computer-executable instructions stored thereon that, when executed by the processor, cause the system to consolidate the respective amount due for each of the consumer bills to obtain a total amount due, and wherein transmitting a request to an employer or payroll processor for the consumer to withhold the amount due from the consumer's paycheck further comprises transmitting a request to withhold the total amount due from the consumer's paycheck.

13. The system of claim 11, wherein the enrollment information comprises the consumer's demographic information or account information for the consumer bill.

14. The system of claim 11, wherein the information related to the consumer bill further includes a due date for the consumer bill.

15. The system of claim 14, wherein:
the information related to the consumer bill is obtained during a pay period for the consumer,
the request to withhold the amount due from the consumer's paycheck is transmitted to the employer or payroll processor for the consumer during the pay period, and
the amount due is paid on behalf of the consumer before the due date.

16. The system of claim 11, wherein the payment reminder for the consumer bill is an e-mail or a push notification.

17. The system of claim 11, wherein paying the amount due on behalf of the consumer further comprises authorizing a credit transfer from a designated account.

18. The system of claim 17, wherein the credit transfer is an automated clearing house (ACH) credit transfer.

19. The system of claim 11, wherein the memory has further computer-executable instructions stored thereon that, when executed by the processor, cause the system to transmit a confirmation of payment of the consumer bill to the consumer.

20. The system of claim 11, wherein the memory has further computer-executable instructions stored thereon that, when executed by the processor, cause the system to transmit a payment report for the consumer bill to a credit reporting agency.
